(19) United States
(12) Patent Application Publication
(10) Pub. No.: US 2015/0172168 A1
(43) Pub. Date: Jun. 18, 2015

(54) PATH SELECTION IN AN ANONYMITY NETWORK

(71) Applicant: THOMSON LICENSING, Issy de Moulineaux (FR)

(72) Inventors: Fabio Picconi, Paris (FR); Adrien Verge, Issy Les Moulineaux (FR)

(73) Assignee: THOMSON LICENSING, Issy de Moulineaux (FR)

(21) Appl. No.: 14/413,695

(22) PCT Filed: Jul. 8, 2013
(86) PCT No.: PCT/EP2013/064348

§ 371 Date: Jan. 8, 2015

(30) Foreign Application Priority Data
Jul. 9, 2012 (EP) 12305818.2

(51) Int. Cl. H04L 12/733; H04L 12/911; H04L 29/06; H04L 12/751

(52) U.S. Cl. CPC H04L 45/126; H04L 45/122; H04L 45/02; H04L 47/825; H04L 63/04

(57) ABSTRACT

Method for constructing a circuit between a first terminal and a second terminal in an anonymity network, said circuit comprising a plurality of consecutive paths, each path linking two adjacent nodes of the network, wherein the paths of the circuit link nodes selected from the k-closest nodes to the first terminal, where k is a determined positive integer.

### FIELD OF THE INVENTION

The present invention generally relates to the field of anonymity networks, like The Onion Router network, known as Tor.

More particularly, the invention deals with path selection in such network.

Thus, the invention concerns a method for constructing a circuit between two terminals in an anonymity network. It also concerns a terminal and a computer program implementing the method of the invention.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Tor is a popular anonymity network formed by volunteer nodes all around the world. It preserves user privacy by encrypting all traffic and relaying it through a series of randomly chosen nodes. This allows users to communicate with any host on the Internet while hiding their identity, including their IP address.

More particularly, Tor is a network of virtual tunnels that allows people and groups to improve their privacy and security on the Internet. Tor is described in detail in the paper from Roger Dingledine, Nick Mathewson, and Paul Syverson: “Tor: The second-generation onion router”, 2004.

Tor works as a set of onion routers located all over the world, and a set of end-users willing to ensure their privacy. In order to achieve anonymous communications within the Internet, an end-user connects to an onion proxy, most of the time running on his/her own machine. The onion proxy creates a circuit through the Tor network that consists on a path among the onion routers. The user then sends the contents of his/her TCP (Transmission Control Protocol) connections to the proxy, whose role is then to tunnel them through the circuit. The last onion router of the circuit connects to the destination the user wants to reach, and transfers the connection contents back to the user.

Thus, a Tor communication in a circuit flows through much more Internet routers than a direct connection, and thus is more sensitive to packet loss, delay and bandwidth bottlenecks. For instance, FIG. 1 illustrates Tor's general design.

In this FIG. 1, Alice communicates with Bob indirectly by creating a 3-node circuit, i.e. a circuit comprising three nodes, among Tor's onion routers (ORs). Here, Bob only knows the last, i.e. the third, OR's IP address. Here, Alice is a client and Bob could be another client, in the case of a peer-to-peer network, or a server, in the case of client-server communications. The 3-node circuit is created between Alice and the last node, i.e. router, in the Tor network. This circuit is encrypted. The link between the last node and Bob may be a regular non-encrypted link or an encrypted link, depending on the application.

One of the most critical points in a circuit's performance and security is the choice of the onion routers. The original Tor path selection algorithm aims at finding a good balance between performance and security.

In Tor's original algorithm, the onion proxy creates a circuit by choosing three onion routers (OR) among the Tor network, and initializes a connection through this path. This value of three has been discussed and evaluated in the paper from Kevin Bauer, Joshua Juen, Nikita Borisov, Dirk Grunwald, Douglas Sicker, and Damon McCoy : “On the optimal path length for tor”, 2010. It seems a good compromise as 2-OR paths, i.e. paths having two onion routers, may leak security whereas 4-OR paths, i.e. paths having 4 onion routers, induce latencies and bandwidth loss.

To ensure non-predictability of paths, the three onion-routers are chosen at random, using the onion router's declared bandwidth as a weight in the selection algorithm. The faster a router is, the more likely it will be selected in a path. Therefore, the probability of selecting a given router is proportional to its declared bandwidth. In practice, this probability is also modified by the OR's flags, e.g. the Exit flag and the Guard flag.

The main advantage of Tor's original path selection is to distribute load evenly, i.e., not overloading low-bandwidth routers. However, the simplicity of the method also leads to poor latency and bandwidth. These disadvantages have lead many researchers to design custom path selection algorithms that enhance bandwidth, latency or anonymity.

A paper from Robin Snader and Nikita Borisov : “A Tune-up for Tor: Improving Security and Performance in the Tor Network”, 2008, presents improvements to make Tor tunable, in order to let the user choose a continuous parameter between maximum-anonymous connections and maximum-bandwidth ones. Depending on this parameter, the circuit selection algorithm varies from totally random paths to paths mostly traversing fast routers.

A paper from Andriy Panchenko and Johannes Renner : “Path Selection Metrics for Performance-Improved Onion Routing”, 2009, proposes methods to measure performance of circuits, ranking them according to their round-trip time (RTT), their bandwidth or the anonymity they provide. Using this implementation, the performance of Tor can be effectively improved. The paper from Can Tang and Ian Goldberg : “An Improved Algorithm for Tor Circuit Scheduling”, 2010, proposes to prioritize bursty circuits, i.e., interactive ones like web browsing, over busy ones such as those used for bulk transfer, like BitTorrent. For each node-to-node TLS (Transport Layer Security) connection which carries several circuits, the source node should compute the exponentially weighted moving average (EWMA) of each circuit and prioritize the burstiest ones. Experiments in the real Tor network show that latency is decreased from 10% to 20% for interactive streams, whereas there are no significant changes on long-term bulk transfers. This improvement is included in Tor since version 0.2.1.21.

In a paper from Tao Wang, Kevin Bauer, Clara Forero, and Ian Goldberg : “Congestion-aware Path Selection for Tor”, 2011, latency is used as an indicator of a node's congestion. The authors introduce a method to determine a node's estimated congestion. Each client stores this information and uses it in a modified path selection algorithm that can save up to 40% of the delay. The paper also proposes ways for clients to respond to short-term, transient congestion by keeping active circuits in background and jumping to them in case of congestion on the current circuit.

A paper from Masoud Akhoondi, Curtis Yu, and Harsha V. Madhyastha : “LASTor: A Low-Latency AS-Aware Tor Client”, 2012, proposes a solution that addresses two issues: latency due to inefficiency in path selection, and degradation of anonymity because the selection of entry and exit routers often induces routing via the same Autonomous System (AS) which might be an eavesdropping AS. The geographical world is divided into square cells, where relays are clustered. Then, the path selection algorithm is performed on clusters, weighting each circuit with the sum of distances it corresponds to. To avoid potentially snooping AS, the client runs a Dijkstra algorithm to obtain a set of candidate ASes through which the Internet is highly likely to route traffic, and avoid corresponding entry node/exit node couples. The problem of the proposed path selection algorithm presented in this paper is that it requires a set of nodes that make Domain Name System (DNS) resolution as a service for LASTor (Latency AS-Aware Tor) clients, which needs the destination's IP address but can't resolve it directly. By default, Tor prevents selection of ORs in the same subnet. A paper from Matthew Edman and Paul Syverson : “AS-awareness in Tor Path Selection”, 2009, shows that this is not enough to ensure that two ORs are not within the same AS. They infer AS-level routing paths and Border Gateway Protocol (BGP) routing data. This data is used to determine which ASes are going to be crossed by a given Tor circuit in order to avoid potentially eavesdropping ASes and improve anonymity.

Thus, the prior work mainly focuses on latency. Existing studies that focus on improving bandwidth rely on nodes measuring available bandwidth to other nodes, and biasing path selection towards fast routers. In addition, studies focusing on bandwidth have not evaluated the load balance properties of these solutions.

### SUMMARY OF THE INVENTION

The present invention proposes a solution for improving the situation.

Accordingly, the present invention provides a method for constructing a circuit between a first terminal and a second terminal in an anonymity network, said circuit comprising a plurality of consecutive paths, each path linking two adjacent nodes of the network, wherein the paths of the circuit link nodes selected from the k-closest nodes to the first terminal, where k is a determined positive integer.

Each of the first and the second terminal may be a server or a client.

By choosing the k-closest nodes to the first terminal, the present invention allows an increase of the bandwidth obtained by said first terminal, a decrease of the network cost for the network operator and a good load balancing between the nodes of the network.

Preferably, the anonymity network is The Onion Router, Tor, network.

The nodes consist, in this case, in routers.

According to a first embodiment, the k-closest nodes to the first terminal are the closest in terms of Autonomous System-hop distance, called AS-hop.

An AS, or Autonomous System, is a collection of connected Internet Protocol (IP) routing prefixes under the control of one or more network operators that presents a common, clearly defined routing policy to the Internet. This notion of Autonomous System is described in the IETF RFC 1930 document : “Guidelines for creation, selection, and registration of an Autonomous System (AS)”.

Given an IP route between any two nodes in the internet, the AS-hop distance is defined as an integer representing the number of AS boundaries that such route traverses. According to a second embodiment, the k-closest nodes to the first terminal are the closest in terms of geographical distance.

Advantageously, k is higher than three and the paths traverse three of the k-closest nodes to the first terminal.

The value of three constitutes a good compromise between security, latency and bandwidth loss.

Advantageously, k is determined as a function of a desired anonymity for the first terminal.

In this case, the choice of k is independent from a bandwidth obtained by the first terminal.

Alternatively, k is determined as a function of a desired bandwidth for the first terminal.

In this case, the anonymity becomes secondary. For instance, the highest value of k providing the desired bandwidth may be chosen.

The invention also provides a first terminal connected to an anonymity network, said first terminal comprising a construction means for constructing a circuit between said first terminal and a second terminal in the anonymity network, said circuit comprising a plurality of consecutive paths, each path linking two adjacent nodes of the network, wherein the paths of the circuit link the k-closest nodes to the first terminal, where k is a determined positive integer.

The method according to the invention may be implemented in software on a programmable apparatus. It may be implemented solely in hardware or in software, or in a combination thereof.

Since the present invention can be implemented in software, the present invention can be embodied as computer readable code for provision to a programmable apparatus on any suitable carrier medium. A carrier medium may comprise a storage medium such as a floppy disk, a CD-ROM, a hard disk drive, a magnetic tape device or a solid state memory device and the like.

The invention thus provides a computer-readable program comprising computer-executable instructions to enable a computer to perform the method of the invention.

### BRIEF DESCRIPTION OF THE DRAWINGS

The present invention is illustrated by way of examples, and not by way of limitation, in the figures of the accompanying drawings, in which like reference numerals refer to similar elements and in which:

FIG. 1, already described, is a schematic view of a Tor network ;

FIG. 2 is a schematic view of a circuit constructed according to a first embodiment of the method of the present invention; and

FIG. 3 is a schematic view of a circuit constructed according to a second embodiment of the method of the present invention.

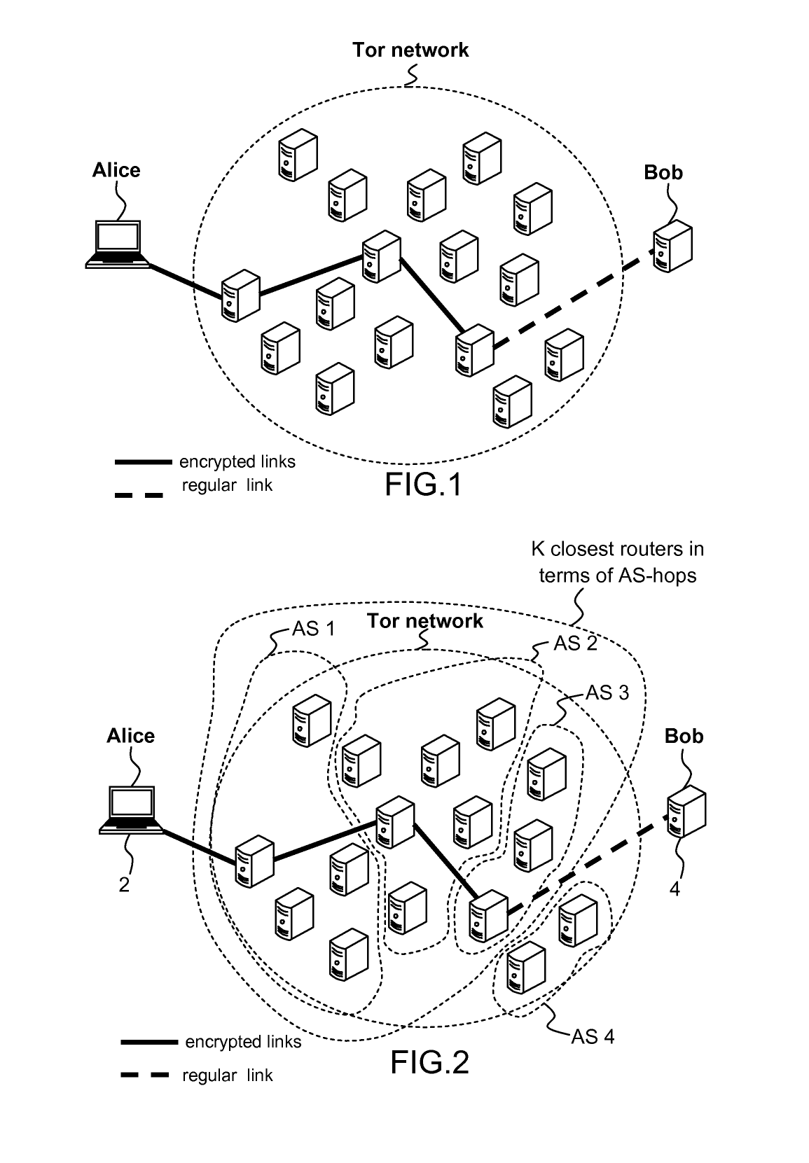

### DETAILED DESCRIPTION OF PREFERRED EMBODIMENTS

The preferred embodiments of the present invention focus on high-bandwidth transfers over a Tor network, and aim at localizing traffic, leading to a reduction of costs for Internet Service Providers (ISP) and an improvement of bulk transfer performance for end users. Typical target applications for the present invention are commercial file download and video streaming services. Therefore, it is assumed here that users are willing to trade some anonymity in order to achieve acceptable performance in terms of bandwidth.

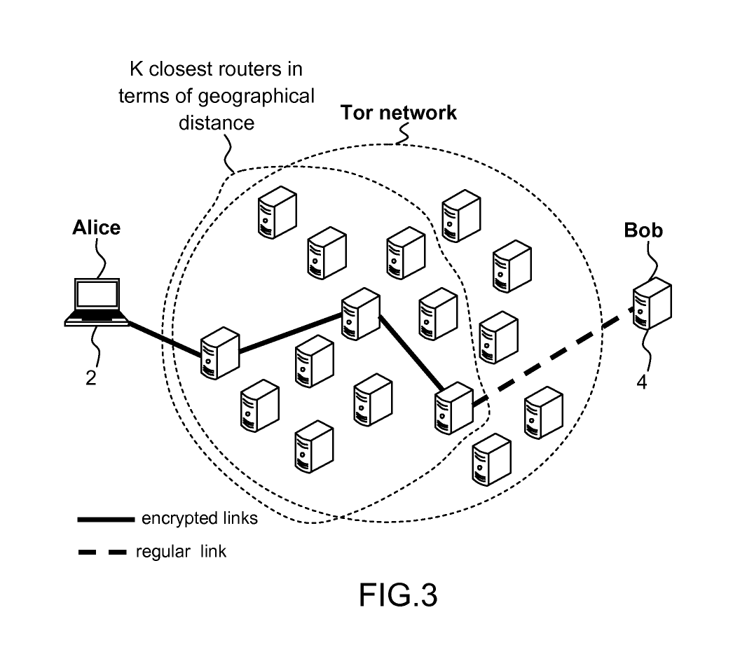

In the following description, illustrated with reference to FIGS. 2 and 3, a circuit is constructed between a first terminal 2, called Alice, and a second terminal 4, called Bob. For instance, Alice is a client and Bob is a server. However, both of Alice and Bob may also be clients or servers. According to a first embodiment, illustrated in FIG. 2, clients select AS-friendly paths, which we can describe as follows: An AS-friendly Tor circuit is a circuit whose paths cross a limited number of AS boundaries.

In order to generate AS-friendly paths, data describing relationships between ASes is used by the client Alice, particularly by a construction module of Alice. Such data is available on the Internet. For example, the Cooperative Association for Internet Data Analysis (CAIDA) provides an AS relationship dataset on its website.

This dataset is used here by the client Alice to determine its k-closest nodes, i.e. routers, in terms of AS-hop distance, and then generate paths that traverse three nodes chosen at random among these k, using the node's declared bandwidth as a weight. The faster a router among the k-closest ones, the more likely it will be selected in a path. Therefore, the probability of selecting a given router is proportional to its declared bandwidth.

In the example of FIG. 2, the autonomous system AS1 is at AS-hop distance 1, the autonomous system AS2 is at AS-hop distance 2, the autonomous system AS3 is at AS-hop distance 3, and the autonomous system AS4 is at AS-hop distance 4 from the client Alice. Therefore, the autonomous systems AS1 and AS2 are neighboring ASes, as well as the autonomous systems AS2 and AS3, and the autonomous systems AS3 and AS4. To determine the k-closest routers, the client Alice begins with a empty list of routers. It then adds the routers localized at AS-hop distance 1, i.e. the routers contained in the autonomous system AS1, then the routers at distance AS-hop distance 2, i.e. the routers contained in the autonomous system AS2, and so on, until the list contains k routers.

Preferably, if the adding of all the routers at AS-hop distance i makes the total cumulated number of selected routers higher than k routers, then the client Alice chooses only a subset of routers at AS-hop distance i so that the list of selected routers contains exactly k routers. Such subset is, for instance, chosen at random from the routers located at distance i.

Thus, the proposed algorithm of the first embodiment comprises the steps of :
selecting the k-closest onion routers, in terms of AS-hop distance to the client;
selecting three onion routers at random among the k-closest onion routers, using the declared bandwidth as a weight.

The present invention also proposes a second path selection algorithm, illustrated in FIG. 3, that uses geographical locations of nodes instead of AS-hop distance. The assumption here is that geographical proximity is, at least to some degree, correlated with proximity in the network topology.

Thus, the proposed algorithm comprises the steps of:
selecting the k-closest onion routers, in terms of geographical distance to the client;
selecting three onion routers at random among the k-closest onion routers, using the declared bandwidth as a weight.

In order to geolocalize routers, the MaxMind's GeoIP database may be advantageously used. This database is provided along with an Application Programming Interface (API) which can return the coordinates, i.e. longitude and latitude, of a given IP address. Integrating this API, a Tor client can choose a set of routers among the ones that are closest to it.

In the example of FIG. 3, the dotted line represents the k-closest routers to the client Alice in terms of geographical distance. Such distance is computed by geolocalizing the client Alice and each router in the Tor network.

Finally, a 3-node circuit is created traversing the k-closest nodes obtained according to the first or to the second algorithm. More particularly, the circuit is created between Alice and the last node, i.e. router, in the Tor network. This circuit is encrypted. The link between the last node and Bob is here a regular non-encrypted link. However, this link may be also an encrypted link, if this is desirable.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention includes all embodiments falling within the scope of the appended claims.

Expressions such as “comprise”, “include”, “incorporate”, “contain”, is and “have” are to be construed in a non-exclusive manner when interpreting the description and its associated claims, namely construed to allow for other items or components which are not explicitly defined also to be present. Reference to the singular is also to be construed to be a reference to the plural and vice versa.

A person skilled in the art will readily appreciate that various parameters disclosed in the description may be modified and that various embodiments disclosed and/or claimed may be combined without departing from the scope of the invention.

In the above presented embodiments, k may be determined as a function of a desired anonymity of the client, i.e. the first terminal here. In this case, the choice of k is independent from a bandwidth obtained by the client.

Alternatively, k may be determined as a function of a desired bandwidth for the client. In this case, the anonymity becomes secondary. For instance, the highest value of k providing the desired bandwidth may be chosen. In this case, it is assumed that the bandwidth actually obtained varies as a function of k, which is generally verified.

1. Method for constructing a circuit between a first terminal and a second terminal in an anonymity network, said circuit comprising a plurality of consecutive paths, each path linking two adjacent nodes of the network, wherein the paths of the circuit link nodes selected from the k-closest nodes to the first terminal, where k is a determined positive integer.

2. Method of claim 1, wherein the anonymity network is The Onion Router, Tor, network.

3. Method of claim 1, wherein the the k-closest nodes to the first terminal are the closest in terms of Autonomous System-hop distance, called AS-hop.

4. Method of claim 1, wherein the k-closest nodes to the first terminal are the closest in terms of geographical distance.

5. Method of claim 1, wherein k is higher than three and the paths traverse three of the k-closest nodes to the first terminal.

6. Method of claim 1, wherein k is determined as a function of a desired anonymity for the first terminal.

7. Method of claim 1, wherein k is determined as a function of a desired bandwidth for the first terminal.

8. First terminal connected to an anonymity network, said first terminal comprising a construction module for constructing a circuit between said first terminal and a second terminal in the anonymity network, said circuit comprising a plurality of consecutive paths, each path linking two adjacent nodes of the network, wherein the paths of the circuit link the k-closest nodes to the first terminal, where k is a determined positive integer.

9. Computer-readable program comprising computer-executable instructions to enable a computer to perform the method of claim 1.
